(19) United States
(12) Patent Application Publication
(10) Pub. No.: US 2018/0275734 A1
(43) Pub. Date: Sep. 27, 2018

(54) POWER TRANSMISSION CABLE AND POWER TRANSMISSION APPARATUS

(71) Applicant: CANYON SEMICONDUCTOR INC., Hsinchu City (TW)

(72) Inventors: Chi-Ming CHEN, Hsinchu City (TW); Cheng-Huang CHEN, Hsinchu City (TW)

(21) Appl. No.: 15/913,720

(22) Filed: Mar. 6, 2018

(30) Foreign Application Priority Data
Mar. 21, 2017 (TW) 106109252

(51) Int. Cl. G06F 1/26; G06F 13/42; H01R 24/62; H01R 13/66

(52) U.S. Cl. CPC G06F 1/266; G06F 13/4282; H01R 2107/00; H01R 13/665; G06F 2213/0042; H01R 24/62

(57) ABSTRACT

A power transmission cable and a power transmission apparatus are provided. The power transmission cable comprises a Universal Serial Bus (USB) Type-C interface, a control circuit, and a Direct Current (DC) output terminal, wherein the control circuit is electrically connected to the USB Type-C interface and the DC output terminal. When the USB Type-C interface is connected to a USB Power Delivery (PD) transformer, the control circuit performs a handshake procedure with the USB PD transformer according to a USB PD protocol to confirm a designated voltage value. After the handshake procedure, the USB Type-C interface receives a power with the designated voltage value from the USB PD transformer and the DC output terminal outputs the power.

### PRIORITY CLAIM

This application claims priority to Taiwan Patent Application No. 106109252 filed on Mar. 21, 2017, which is hereby incorporated by reference in its entirety.

### CROSS-REFERENCES TO RELATED APPLICATIONS

Not applicable.

### BACKGROUND OF THE INVENTION

### Field of the Invention

The present invention provides a power transmission cable and a power transmission apparatus. More particularly, the present invention provides a power transmission cable and a power transmission apparatus that are related to the Universal Serial Bus Power Delivery (USB PD).

### Descriptions of the Related Art

Technologies of Universal Serial Bus (USB) have been developing rapidly. The two most important technologies are the USB Type-C interface and the USB Power Delivery (PD) protocol. Transformers combined with the USB Type-C interface and the USB PD protocol are currently available. This kind of transformer can output a power, of which the voltage value ranges between 3 volts and 20 volts via the USB Type-C interface thereof. The maximum output power thereof can be up to 100 watts. Since this kind of transformer can provide a power with a relatively wide voltage, they are expected to be used widely as power supplies in the art.

Although the voltage value of the power provided by this kind of transformer is variable, power receiving apparatuses have to implement the USB PD protocol to communicate with the transformers serving as the power supplies so that the transformers output a power with an appropriate voltage value to the power receiving apparatus. Therefore, this kind of transformer cannot be used for numerous electronic devices currently available on the market which need Direct Current (DC) power but are incapable of implementing the USB PD protocol. For manufacturers of electronic devices, the cost is too high if the electronic devices have to be re-designed to be capable of implementing the USB PD protocol.

Accordingly, it is important to enable electronic devices, which need DC power but are incapable of implementing the USB PD protocol, to use the aforesaid transformers as the power supplies.

### SUMMARY OF THE INVENTION

To solve the aforesaid problem, the present invention provides a power transmission cable and a power transmission apparatus.

The power transmission cable of the present invention comprises a Universal Serial Bus (USB) Type-C interface, a control circuit, and a Direct Current (DC) output terminal. The control circuit is electrically connected to the USB Type-C interface and the DC output terminal. The control circuit performs a handshake procedure with a USB Power Delivery (PD) transformer according to a USB PD protocol to confirm a designated voltage value when the USB Type-C interface is connected to the USB PD transformer. After the handshake procedure, the USB Type-C interface receives a power with the designated voltage value from the USB PD transformer and the DC output terminal outputs the power.

The power transmission apparatus of the present invention comprises a Universal Serial Bus (USB) Type-C interface, a control circuit, and a Direct Current (DC) output terminal. The control circuit is electrically connected to the USB Type-C interface and the DC output terminal. The control circuit performs a handshake procedure with a USB Power Delivery (PD) transformer according to a USB PD protocol to confirm a designated voltage value when the USB Type-C interface is connected to the USB PD transformer. After the handshake procedure, the USB Type-C interface receives a power with the designated voltage value from the USB PD transformer and the DC output terminal outputs the power.

The control circuit included in the power transmission cable/apparatus of the present invention is capable of implementing the USB PD protocol, so it can inform the USB PD transformer of the designated voltage value that is required via a handshake procedure. Moreover, the power transmission cable/apparatus of the present invention has a DC output terminal, so it can output a power that is outputted by the USB PD transformer and has the designated voltage value to a DC electronic device which requires the power. In some embodiments of the present invention, the power transmission cable/apparatus further comprises one or more operation modules through which a user can rely on their using requirement to input the designated voltage value or adjust a preset voltage value to the designated voltage value. Through the aforesaid mechanism, the power transmission cable/apparatus of the present invention enables electronic devices that need the DC power but are incapable of implementing the USB PD protocol, to use the USB PD transformers as the power supplies.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a schematic view of a power transmission cable 11 of the first embodiment and a Universal Serial Bus (USB) Power Delivery (PD) transformer 13 used in combination with the power transmission cable 11;

FIG. 2 illustrates a schematic view of a power transmission cable 21 of the second embodiment and the USB PD transformer 13 used in combination with the power transmission cable 21;

FIG. 3 illustrates a schematic view of a power transmission cable 31 of the third embodiment and the USB PD transformer 13 used in combination with the power transmission cable 31;

FIG. 4 illustrates a schematic view of a power transmission cable 41 of the fourth embodiment and the USB PD transformer 13 used in combination with the power transmission cable 41;

FIG. 5 illustrates a schematic view of a power transmission apparatus 51 of the fifth embodiment;

FIG. 6 illustrates a schematic view of a power transmission apparatus 61 of the sixth embodiment;

FIG. 7 illustrates a schematic view of a power transmission apparatus 71 of the seventh embodiment; and

FIG. 8 illustrates a schematic view of a power transmission apparatus 81 of the eighth embodiment.

### DESCRIPTION OF THE PREFERRED EMBODIMENT

In the following description, the power transmission cable and the power transmission apparatus of the present invention will be explained with reference to embodiments thereof. However, these embodiments of the present invention are not intended to limit the present invention to any environment, applications, or implementations described in these embodiments. Therefore, description of these embodiments is only for purpose of illustration rather than to limit the scope of the present invention. It shall be appreciated that in the following embodiments and the attached drawings, elements unrelated to the present invention are omitted from depiction; and dimensions of elements and dimensional relationships among individual elements in the attached drawings are only for the purpose of illustration, but not to limit the scope of the present invention.

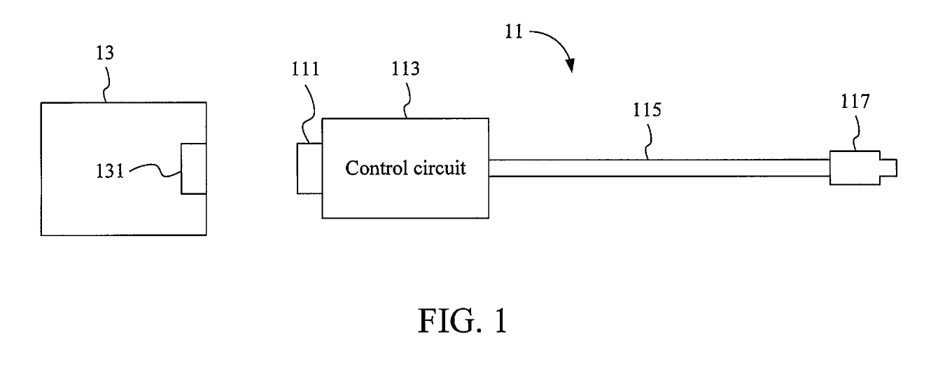

FIG. 1 is a schematic view depicting a power transmission cable 11 and a Universal Serial Bus (USB) Power Delivery (PD) transformer 13 used in combination with the power transmission cable 11 according to the first embodiment of the present invention. The power transmission cable 11 comprises a Universal Serial Bus (USB) Type-C interface 111, a control circuit 113, a power cable 115, and a Direct Current (DC) output terminal 117. The USB Type-C interface 111 is electrically connected to the control circuit 113, and the control circuit 113 is electrically connected to the DC output terminal 117 via the power cable 115. Moreover, the USB PD transformer 13 has a USB Type-C interface 131.

It shall be appreciated that in an embodiment, the USB Type-C interface 111 is a USB Type-C plug while the USB Type-C interface 131 is a USB Type-C receptacle. However, in another embodiment, the USB Type-C interface 111 may be a USB Type-C receptacle, and thus the USB Type-C interface 131 needs to be a USB Type-C plug fitting with the receptacle. Furthermore, in some embodiments, the control circuit 113 may be accommodated within a housing.

In this embodiment, a designated voltage value (not shown), e.g., 12 volts, is set in the control circuit 113. The control circuit 113 performs a handshake procedure (not shown) with the USB PD transformer 13 according to a USB PD protocol (not shown) to confirm the designated voltage value when the USB Type-C interface 111 of the power transmission cable 11 is connected to the USB Type-C interface 131 of the USB PD transformer 13. In other words, through the handshake procedure, the control circuit 113 informs the USB PD transformer 13 of the designated voltage value. After the handshake procedure, the USB PD transformer 13 outputs a power (not shown) with the designated voltage value via the USB Type-C interface 131. The power transmission cable 11 receives the power with the designated voltage value via the USB Type-C interface 111, and the DC output terminal 117 outputs the power with the designated voltage value.

It shall be appreciated that the USB Type-C interface 111 comprises a power pin (V_{bus} pin) (not shown), a first configuration channel pin (CC pin) (not shown), and a second configuration channel pin (V_{conn} pin) (not shown). Configurations of these pins are specified by USB standards and thus will not be further described herein. In some embodiments, the control circuit 113 performs the handshake procedure with the USB PD transformer 13 via the first configuration channel pin of the USB Type-C interface 111. The control circuit 113 receives the power via the power pin or the second configuration channel pin of the USB Type-C interface 111 after the handshake procedure.

It shall be additionally appreciated that the DC output terminal 117 may be a DC jack plug or a pair of DC output ends in some embodiments. Furthermore, in some embodiments, the power transmission cable 11 may further comprise a display unit (not shown) to display the designated voltage value.

Through the aforesaid operation mechanism, electronic devices (especially those incapable of implementing the USB PD protocol) that require the DC power can obtain the power provided by the USB PD transformer 13 when the DC input terminal of these electronic devices is connected to the DC output terminal 117.

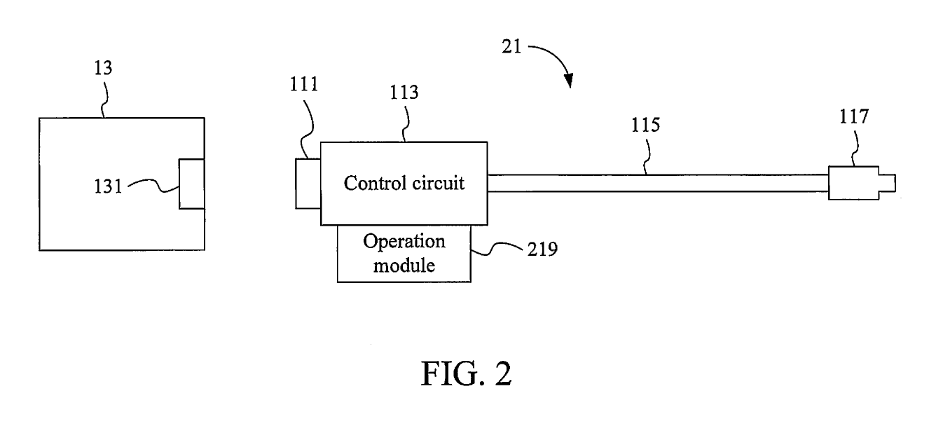

FIG. 2 is a schematic view depicting a power transmission cable 21 and the USB PD transformer 13 used in combination with the power transmission cable 21 according to the second embodiment of the present invention. Elements comprised in the power transmission cable 21 of the second embodiment are the same as those comprised in the power transmission cable 11 of the first embodiment, and those elements can perform the same operations, and thus, only differences between the power transmission cable 21 and the power transmission cable 11 will be described in detail hereinafter.

As compared to the power transmission cable 11 of the first embodiment, the power transmission cable 21 further comprises an operation module 219 in addition to the USB Type-C interface 111, the control circuit 113, the power cable 115, and the DC output terminal 117. The operation module 219 is electrically connected to the control circuit 113. In some embodiments, the control circuit 113 may be accommodated within a housing, while the operation module 219 may be disposed on the surface of the housing. The operation module 219 is provided with a plurality of preset voltage values (e.g., four preset voltage values, namely, 3 volts, 6 volts, 9 volts, and 12 volts) for the user to choose. For example, the operation module 219 may be a contactless operation module, a touch operation module, a push button operation module, or a knob type operation module.

In this embodiment, no designated voltage value may be set in the control circuit 113. The user may perform an operation (e.g., pressing, rotating) on the operation module 219 to set one of the preset voltage values as the designated voltage value. After the user has set the designated voltage value via the operation module 219 and the USB Type-C interface 111 of the power transmission cable 21 is connected to the USB Type-C interface 131 of the USB PD transformer 13, the power transmission cable 21 informs the USB PD transformer 13 of the designated voltage value during the handshake procedure.

Similarly, after the handshake procedure, the USB PD transformer 13 outputs a power (not shown) with the designated voltage value via the USB Type-C interface 131. The power transmission cable 21 receives the power with the designated voltage value via the USB Type-C interface 111, and the DC output terminal 117 outputs the power with the designated voltage value.

It shall be appreciated that in some embodiments, the control circuit 113 disables the operation module 219 when the USB Type-C interface 111 receives the power from the USB PD transformer 13 and the DC output terminal 117 outputs the power. In this way, when an electronic device is receiving the power provided by the USB PD transformer 13 via the power transmission cable 21, the designated voltage value will not be changed and cause damage to the electronic device even if the user touches the operation module 219 by accident. In some embodiments, the power transmission cable 21 may be further provided with a circuit, a push button or a switch to achieve the aforesaid function of disabling the operation module.

In addition to the aforesaid operations, the second embodiment can also execute all the operations set forth in the first embodiment, have the same functions, and deliver the same technical effects as the first embodiment. The way that the second embodiment executes these operations, has the same functions, and delivers the same technical effects as the first embodiment shall be readily appreciated by a person of ordinary skill in the art based on the explanation of the first embodiment, and thus, will not be further described herein.

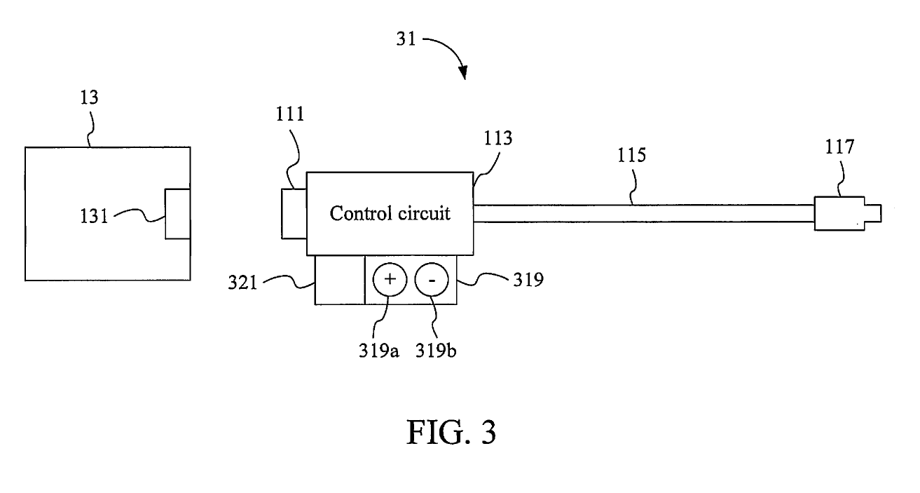

FIG. 3 is a schematic view depicting a power transmission cable 31 and the USB PD transformer 13 used in combination with the power transmission cable 31 according to the third embodiment of the present invention. Elements comprised in the power transmission cable 31 of the third embodiment are the same as those comprised in the power transmission cable 11 of the first embodiment, and those elements can perform the same operations. Therefore, only differences between the power transmission cable 31 and the power transmission cable 11 will be described in detail hereinafter.

Comparing to the power transmission cable 11 of the first embodiment, the power transmission cable 31 further comprises an operation module 319 and a display unit 321 in addition to the USB Type-C interface 111, the control circuit 113, the power cable 115, and the DC output terminal 117. The operation module 319 is electrically connected to the control circuit 113 and the display unit 321. In some embodiments, the control circuit 113 may be accommodated within a housing, while the operation module 319 and the display unit 321 may be disposed on the surface of the housing.

In this embodiment, an initial voltage value (not shown), e.g., 9 volts, is set in the control circuit 113. The operation module 319 adjusts the initial voltage value to a designated voltage value in response to an operation of a user. For example, if the voltage value required by the electronic device is 10 volts (i.e., the designated voltage value is 10 volts), the user may press an increment button 319a of the operation module 319 to adjust the initial voltage value to the designated voltage value. As another example, if the voltage value required by the electronic device is 7 volts (i.e., the designated voltage value is 7 volts), the user may press a decrement button 319b of the operation module 319 to adjust the initial voltage value to the designated voltage value.

When the user is using the operation module 319 to adjust the initial voltage value to the designated voltage value, the display unit 321 displays the current voltage value (i.e., gradually changes from displaying the initial voltage value to displaying the designated voltage value) so that the user can know whether the power transmission cable 31 has been adjusted to the designated voltage value.

In addition to the aforesaid operations, the third embodiment can also execute all the operations set forth in the first embodiment, have the same functions, and deliver the same technical effects as the first embodiment. The way that the third embodiment executes these operations, has the same functions, and delivers the same technical effects as the first embodiment shall be readily appreciated by a person of ordinary skill in the art based on the explanation of the first embodiment, and thus will not be further described herein. Moreover, the third embodiment can also have the mechanism of disabling the operation module set forth in the second embodiment. The way that the third embodiment executes this disabling mechanism, has the same functions, and delivers the same technical effects as the second embodiment shall be readily appreciated by a person of ordinary skill in the art based on the explanation of the second embodiment, and thus will not be further described herein.

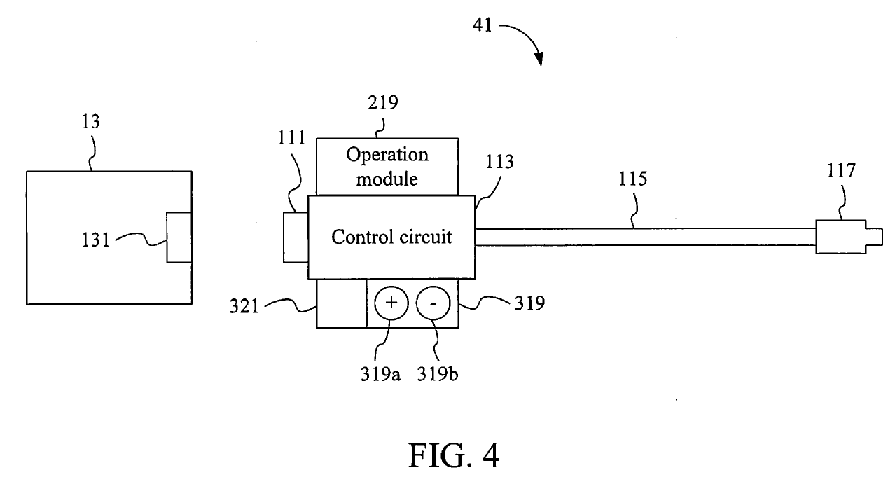

FIG. 4 is a schematic view depicting a power transmission cable 41 and the USB PD transformer 13 used in combination with the power transmission cable 41 according to the fourth embodiment of the present invention. Elements comprised in the power transmission cable 41 of the fourth embodiment are the same as those comprised in the power transmission cable 11 of the first embodiment, and those elements can perform the same operations. Therefore, only differences between the power transmission cable 41 and the power transmission cable 11 will be described in detail hereinafter.

As compared to the power transmission cable 11 of the first embodiment, the power transmission cable 41 further comprises the operation module 219 described in the second embodiment and the operation module 319 and the display unit 321 described in the third embodiment in addition to the USB Type-C interface 111, the control circuit 113, the power cable 115, and the DC output terminal 117.

In this embodiment, an initial voltage value may or may not be set in the control circuit 113. The user may set the designated voltage value by operating the operation module 219 and/or the operation module 319. For example, if the voltage value required by the electronic device is 10 volts (i.e., the designated voltage value is 10 volts), the user may first choose the 9 volts provided by the operation module 219 and then press the increment button 319a of the operation module 319 to adjust the 9 volts to the designated voltage value. Different operating modes provided by the fourth embodiment shall be appreciated by a person of ordinary skill in the art based on the above descriptions of the first to the third embodiments, and thus will not be further described herein.

Similarly, the fourth embodiment can also execute all the operations set forth in the first embodiment, have the same functions, and deliver the same technical effects as the first embodiment. The way that the fourth embodiment executes these operations, has the same functions, and delivers the same technical effects as the first embodiment shall be readily appreciated by a person of ordinary skill in the art based on the explanation of the first embodiment, and thus, will not be further described herein. Moreover, the fourth embodiment can also have the mechanism of disabling the operation module set forth in the second embodiment. The way that the fourth embodiment executes this disabling mechanism, has the same functions, and delivers the same technical effects as the second embodiment shall be readily appreciated by a person of ordinary skill in the art based on the explanation of the second embodiment, and thus, will not be further described herein.

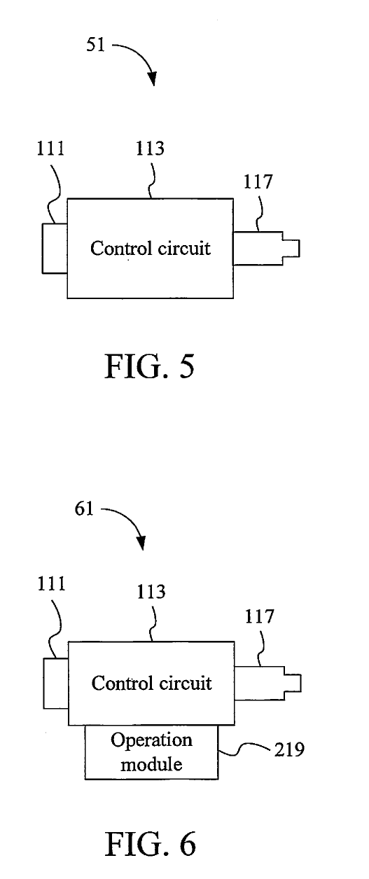

The fifth embodiment of the present invention is a power transmission apparatus 51, and a schematic view thereof is depicted in FIG. 5. The power transmission apparatus 51 comprises the USB Type-C interface 111, the control circuit 113, and the DC output terminal 117. As compared to the power transmission cable 11 of the first embodiment, the power transmission apparatus 51 does not comprise the power cable 115. Except for this, the power transmission apparatus 51 of the fifth embodiment can execute all the operations described for the power transmission cable 11 of the first embodiment, have the same functions, and deliver the same technical effects. The way that the fifth embodiment executes these operations, has the same functions, and delivers the same technical effects as the first embodiment shall be readily appreciated by a person of ordinary skill in the art based on the explanation of the first embodiment, and thus, will not be further described herein.

The sixth embodiment of the present invention is a power transmission apparatus 61, and a schematic view thereof is depicted in FIG. 6. The power transmission apparatus 61 comprises the USB Type-C interface 111, the control circuit 113, the DC output terminal 117 and the operation module 219. As compared to the power transmission cable 21 of the second embodiment, the power transmission apparatus 61 does not comprise the power cable 115. Except for this, the power transmission apparatus 61 of the sixth embodiment can execute all the operations described for the power transmission cable 21 of the second embodiment, have the same functions, and deliver the same technical effects. The way that the sixth embodiment executes these operations, has the same functions, and delivers the same technical effects as the second embodiment shall be readily appreciated by a person of ordinary skill in the art based on the explanation of the second embodiment, and thus will not be further described herein.

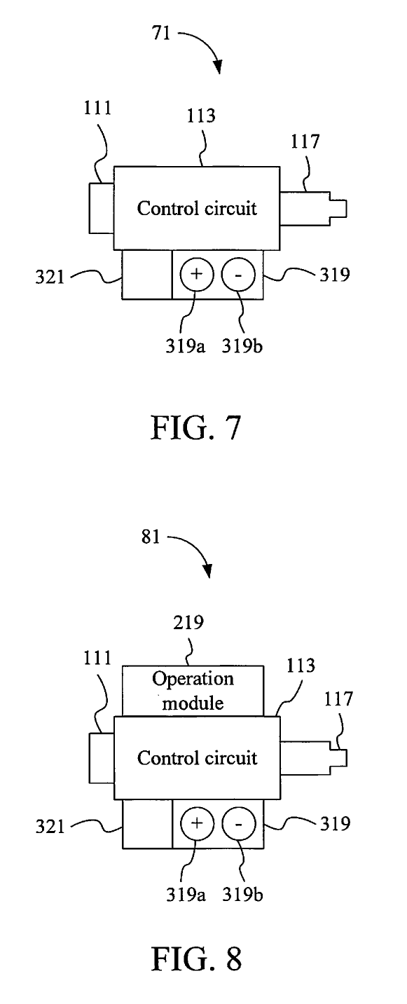

The seventh embodiment of the present invention is a power transmission apparatus 71, and a schematic view thereof is depicted in FIG. 7. The power transmission apparatus 71 comprises the USB Type-C interface 111, the control circuit 113, the DC output terminal 117, the operation module 319, and the display unit 321. As compared to the power transmission cable 31 of the third embodiment, the power transmission apparatus 71 does not comprise the power cable 115. Except for this, the power transmission apparatus 71 of the seventh embodiment can execute all the operations described for the power transmission cable 31 of the third embodiment, have the same functions and deliver the same technical effects. The way that the seventh embodiment executes these operations, has the same functions, and delivers the same technical effects as the third embodiment shall be readily appreciated by a person of ordinary skill in the art based on the explanation of the third embodiment, and thus will not be further described herein.

An eighth embodiment of the present invention is a power transmission apparatus 81, and a schematic view thereof is depicted in FIG. 8. The power transmission apparatus 81 comprises the USB Type-C interface 111, the control circuit 113, the DC output terminal 117, the operation module 219, the operation module 319, and the display unit 321. As compared to the power transmission cable 41 of the fourth embodiment, the power transmission apparatus 81 does not comprise the power cable 115. Except for this, the power transmission apparatus 81 of the eighth embodiment can execute all the operations described for the power transmission cable 41 of the fourth embodiment, have the same functions and deliver the same technical effects. The way that the eighth embodiment executes these operations, has the same functions and delivers the same technical effects as the fourth embodiment shall be readily appreciated by a person of ordinary skill in the art based on the explanation of the fourth embodiment, and thus will not be further described herein.

As can be known from the above descriptions, the power transmission cable/apparatus of the present invention is capable of implementing the USB PD protocol, and thus, it can inform the USB PD transformer of the designated voltage value that is required via a handshake procedure. Moreover, the power transmission cable/apparatus of the present invention has a DC output terminal, so it can output a power that is outputted from the USB PD transformer and is with the designated voltage value for a DC electronic device which requires power. In some embodiments of the present invention, the power transmission cable/apparatus further comprises one or more operation modules through which a user can input the required designated voltage value or adjust a preset voltage value to the required designated voltage value. Through the aforesaid mechanism, the power transmission cable/apparatus of the present invention enables the electronic devices, which need the DC power but are incapable of implementing the USB PD protocol, to use the USB PD transformers as the power supplies.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A power transmission cable, comprising:
a Universal Serial Bus (USB) Type-C interface;
a control circuit, electrically connected to the USB Type-C interface and configured to perform a handshake procedure with a USB Power Delivery (PD) transformer according to a USB PD protocol to confirm a designated voltage value when the USB Type-C interface is connected to the USB PD transformer; and
a Direct Current (DC) output terminal, electrically connected to the control circuit;
wherein after the handshake procedure, the USB Type-C interface receives a power with the designated voltage value from the USB PD transformer and the DC output terminal outputs the power.

2. The power transmission cable of claim 1, wherein the control circuit performs the handshake procedure with the USB PD transformer via a first configuration channel pin (CC pin) of the USB Type-C interface and the control circuit receives the power via one of a power pin (V_{bus} pin) and a second configuration channel pin (V_{conn} pin) of the USB Type-C interface.

3. The power transmission cable of claim 1, wherein the DC output terminal is one of a DC jack plug and a pair of DC output ends.

4. The power transmission cable of claim 1, further comprising:
an operation module, electrically connected to the control circuit, provided with a plurality of preset voltage values, and configured to set one of the preset voltage values as the designated voltage value in response to an operation of a user.

5. The power transmission cable of claim 4, wherein the operation module is one of a contactless operation module, a touch operation module, a push button operation module, and a knob type operation module.

6. The power transmission cable of claim 1, further comprising:
an operation module, electrically connected to the control circuit and configured to adjust an initial voltage value to the designated voltage value in response to an operation of a user; and a display unit, electrically connected to the operation module and configured to display the initial voltage value and the designated voltage value.

7. The power transmission cable of claim 1, further comprising:
a display unit, configured to display the designated voltage value.

8. The power transmission cable of claim 4, wherein the control circuit is further configured to disable the operation module when the USB Type-C interface receives the power from the USB PD transformer and the DC output terminal outputs the power.

9. A power transmission apparatus, comprising:
a Universal Serial Bus (USB) Type-C interface;
a control circuit, electrically connected to the USB Type-C interface and configured to perform a handshake procedure with a USB Power Delivery (PD) transformer according to a USB PD protocol to confirm a designated voltage value when the USB Type-C interface is connected to the USB PD transformer; and
a Direct Current (DC) output terminal, electrically connected to the control circuit;
wherein after the handshake procedure, the USB Type-C interface receives a power with the designated voltage value from the USB PD transformer and the DC output terminal outputs the power.

10. The power transmission apparatus of claim 9, further comprising:
an operation module, electrically connected to the control circuit, provided with a plurality of preset voltage values, and configured to set one of the preset voltage values as the designated voltage value in response to an operation of a user.
